(19) United States
(12) Patent Application Publication
(10) Pub. No.: US 2006/0188260 A1
(43) Pub. Date: Aug. 24, 2006

(54) Robust service delivery node and method therefor

(75) Inventors: John Nikolopoulos, Montreal (CA); Silvo J. Frank, Orleans (CA)

Correspondence Address: FREEDMAN & ASSOCIATES, 117 CENTREPOINTE DRIVE, SUITE 350, NEPEAN, ONTARIO, K2G 5X3, CA

(73) Assignee: Positron Networks PNI Inc., Montreal (CA)

(21) Appl. No.: 11/358,297

(22) Filed: Feb. 22, 2006

Related U.S. Application Data
(60) Provisional application No. 60/654,467, filed on Feb. 22, 2005.
(60) Provisional application No. 60/654,468, filed on Feb. 22, 2005.
(60) Provisional application No. 60/654,469, filed on Feb. 22, 2005.

(51) Int. Cl. H04J 14/02

(52) U.S. Cl. 398/83

(57) ABSTRACT

In an optical network some optical nodes are fitted with optical switches. The optical switches support the optical coupling and decoupling of the optical nodes and the remainder of the optical network. Electrical power supply failures to a node result in the node being optically decoupled from the remainder of the optical network thereby allowing the remaining nodes to continue normal operation.

This application claims benefit from the following U.S. Provisional Applications: No. 60/654,467 filed Feb. 22, 2005; No. 60/654,468 filed Feb. 22, 2006 and No. 60/654,469 filed Feb. 22, 2005, the entire contents of which are incorporated herein by reference.

### FIELD OF THE INVENTION

The invention relates to optical networks. More specifically, the invention relates to a system for automatically bypassing those nodes of an optical network that are not suitable for receiving signals from other nodes.

### BACKGROUND OF THE INVENTION

Use of the Internet has grown dramatically and to that end, core networks featuring long haul high bandwidth fiber optic equipment have been deployed to help support data traffic on the Internet. Internet traffic and other data services are eventually routed to end users via metro and access networks. The metro and access networks are not typically equipped to handle the high data rates and large numbers of wavelengths typically employed in core networks. Additionally, these networks service a relatively small number of users. Consequently, the designers of the metro and access networks are typically very price conscious and, as such, the equipment used to support metro and access applications is comparatively less robust and less complex than core network equipment. That said, certain applications require robust metro and access networks. With this in mind, it is desired to provide inexpensive, low maintenance networking components to service metro and access networks. Unfortunately, these objectives conflict as inexpensive components typically do not provide low mean times between failure.

As metro and access networks are increasingly being considered for applications where the robustness of the data connection is critically important. For example, in many remote areas there is a desire to provide emergency medical services through the Internet. Clearly, this represents a problem in that a remote location is likely to be connected to a robust long haul network via a Sonet network that may comprise less than robust Sonet nodes. The robustness of a Sonet network varies based upon its architecture. Typically, a Sonet ring network is considered to be a very robust design because a given node is capable of communicating with any other node via two separate paths. Unfortunately, even nodes that are often well separated according to a ring diagram are often located in close proximity in other terms, for example, two separate nodes might be dependent upon power from a common electrical power supply. This represents a potential problem in that a localized power failure can produce node failures in multiple, optically separated locations of a Sonet ring network thereby preventing communication between functional nodes of the Sonet ring network.

It would be beneficial to provide a more robust, yet inexpensive architecture for Sonet networks. Additionally, it would be beneficial to provide the capability to upgrade existing Sonet networks to improve their robustness without incurring high costs.

### SUMMARY OF THE INVENTION

The invention teaches an optical network comprising:
a controller;
a plurality of nodes, each of the nodes supporting add-drop functionality, each of the nodes comprising at least an optical port;
at least one of the plurality of nodes optically coupled with an optical switch comprising:
   a control input port for receiving a first control signal;
   an at least an optical switch port optically coupled to the at least an optical port for providing an optical signals thereto and for receiving optical signals therefrom;
   a first optical port for being coupled for receiving an optical signal from the optical network; and,
   a second optical port for being coupled for providing an optical signal to the optical network;
the at least one of the plurality of nodes comprising a control output port for providing a status signal for use by the controller for providing the first control signal therefrom, the control output port being other than the at least an optical port, and;
the switch being responsive to the first control signal and having a first state and a second state such that in the first state an optical signal propagating to the first optical port propagates to the at least an optical port and an optical signal provided from the at least an optical port propagates to the second optical port and, when the switch is in the second state an optical signal propagating to the first optical port propagates to the second optical port.

Embodiments of the invention describe a method of directing data signals in an optical system comprising:
providing an optical network comprising a set of nodes in optical communication via a set of waveguides;
providing a first node;
providing an optical switch optically disposed between the optical network and the first node, the optical switch having a first state in which optical data traffic between the optical network and the node is supported and a second state in which optical data traffic between the optical network and the node is other than supported; and,
receiving a control instruction provided independent of said set of waveguides, the control instruction for controlling a state of the switch.

The invention describes a method of directing data signals in an optical system comprising:
providing an optical network comprising a set of nodes in optical communication via a set of waveguides;
providing a controller, the controller for providing a first control signal and a second control signal;
providing a first node;
providing a first optical switch optically disposed between the optical network and the first node, the first optical switch having a first state in which optical data traffic between the optical network and the node is supported and a second state in which optical data traffic between the optical network and the first node is other than supported, the first optical switch having a first input port for receiving a first input signal other than via the set of waveguides, the first optical switch for changing state in response to the first control signal;
providing a second node;
providing a second optical switch optically disposed between the optical network and the second node, the second optical switch having a first state in which optical data traffic between the optical network and the second node is supported and a second state in which optical data traffic between the optical network and the second node is other than supported, the second optical switch having a second input port for receiving a second input signal other than via the set of waveguides, the second optical switch for changing state in response to the second control signal.

### BRIEF DESCRIPTION OF THE DRAWINGS

The invention is now described with reference to the drawings in which:

FIG. 1 is a diagram of a prior art Sonet ring featuring an inner ring and an outer ring;

FIG. 2 is a diagram of a prior art Sonet ring with add-drop functionality;

FIG. 3 is a diagram of a prior art ring network featuring variable couplers;

FIG. 4a is an optical path diagram of a prior art optical cross connect switch in a first state;

FIG. 4b is an optical path diagram of a the prior art optical cross connect switch of FIG. 4a shown in a second state;

FIG. 5 is a diagram of a Sonet network according to a first embodiment of the invention;

FIG. 6a is an optical path diagram of an optical cross connect switch coupled to an underpowered node;

FIG. 6b is an optical path diagram of an optical cross connect switch coupled to a properly powered node;

FIG. 7 is a schematic diagram of a Sonet UPSR network according to a second embodiment of the invention;

FIG. 8 is a schematic diagram of a linear Sonet network according to a third embodiment of the invention;

FIG. 9 is a schematic diagram of an optical network according to a fourth embodiment of the invention featuring a controller that controls which nodes are in communication with the network; and,

FIG. 10 is a schematic diagram of a mesh optical network according to fifth embodiment of the invention.

### DETAILED DESCRIPTION OF THE INVENTION

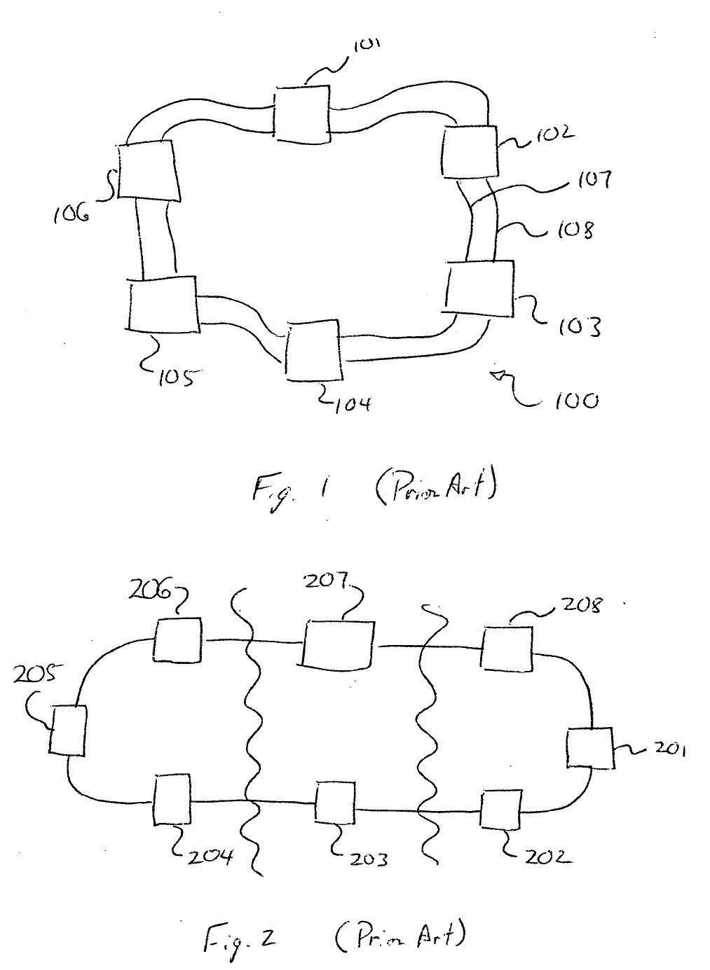

Referring to FIG. 1, a prior art Sonet ring 100 is shown having six nodes 101 to 106. The Sonet ring comprises a first ring 107 and a second ring 108. In the first ring 107 optical signals propagate along the ring in a clockwise direction. In U.S. Pat. No. 4,835,763 Lau teaches operation of a Sonet ring network to compensate for a failure of a communication link between two nodes. Specifically, in the ring configuration there are two routes that support the propagation of information within the ring. In the prior art of Lau both routes are always used. When a single break occurs, an alternative route is already available as taught by Lau. With this in mind, it is understood that a Sonet ring is more robust when the fibers of the ring are not provided in an adjacent fashion to reduce the likelihood of both fibers being damaged by a single event.

The prior art of Lau also permits communication between functioning nodes of the Sonet ring when one of the nodes is nonfunctional. In applications where Sonet node availability is critical it is common to provide a backup power source proximate the node to ensure that the node is not subject to short-term power failures. In many cases, the customers who service the nodes are not concerned with the performance of the node in the event of a power failure. Alternatively, a backup power source dedicated to a specific node may fail. Additionally, such a backup power source will typically have sufficient power to operate the node for a limited time. Once the backup power source is depleted if no other power source is available the node will cease to function.

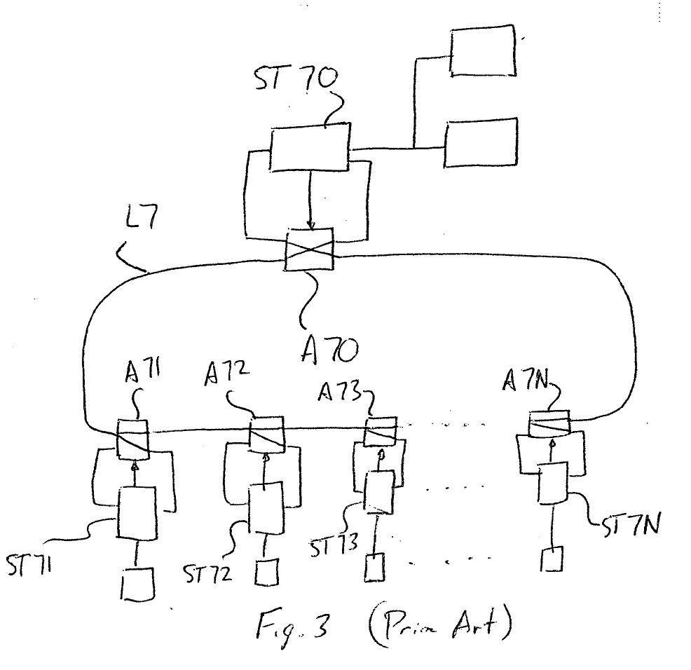

While it is understood that the optical fibers of the Sonet ring should be separated to reduce the likelihood of damage to both fibers from a single event, it is often not practical to ensure that nodes in a metro or access network rely upon different portions of an electrical power grid. Referring to FIG. 2, a Sonet ring 200 is shown having nodes 201 to 208. The Sonet ring 200 uses add-drop functionality. Thus, when signals propagating within the ring arrive at a node they are decoded to electrical signals, interpreted and, if necessary, provided as optical signals the next node. In the case of the network shown in FIG. 2, node 201 supports communication between the other nodes 202 to 208 and an external long-haul network (not shown). Node 201 is considered critical to the operation of the network. Nodes 202, 203 and 207 are considered low priority access devices and, as such, do not feature adequate electrical backup systems. Node 205 is considered a critical node and therefore it is desired to ensure that there is a communications path available between node 205 and node 201. Unfortunately, nodes 203 and 207 are supported by a same portion of an electrical power grid. During a power failure both nodes 203 and 207 do not receive adequate electrical power and, as a result, fail. In this case, both optical paths from 205 to 201 are disrupted and therefore node 205 is no longer in communication with node 201.

Referring to FIG. 3, a prior art optical network consistent with the teachings of U.S. Pat. No. 4,783,851 by Inou et al. (Inou) is shown. The system of Inou is described as comprising variable couplers A70 to A7N that are used to route optical signals from a ring L7 supporting a plurality of local stations ST71 to ST7N to a specific local station. In use, the control of the variable couplers A71 to A7N is dependent upon the proper functioning of the local station proximate the variable coupler as well as a process control system ST70. The process control system ST70 provides optical signals via a variable coupler A70. These optical signals propagate within the ring L7 of the network. The various local stations ST71 to ST7N receive the optical signals. The optical signals are presumably converted to electrical signals, in accordance with the variable coupler designs suggested by Inou, and used to vary the proportion of optical signal being provided to a given local station. The optical signals used to provide control instructions to the variable couplers are provided on the same optical waveguide as the optical data being transferred between the local stations ST71 to ST7N. Thus, even when it is desired for a given local station to not receive a given optical signal it would be expected that the local station continues to receive signals such that it is capable of varying the degree of coupling of the associated variable coupler in accordance with control signals provided by the process control system. In addition, the setting of the variable coupler relies upon proper functioning of the associated local station.

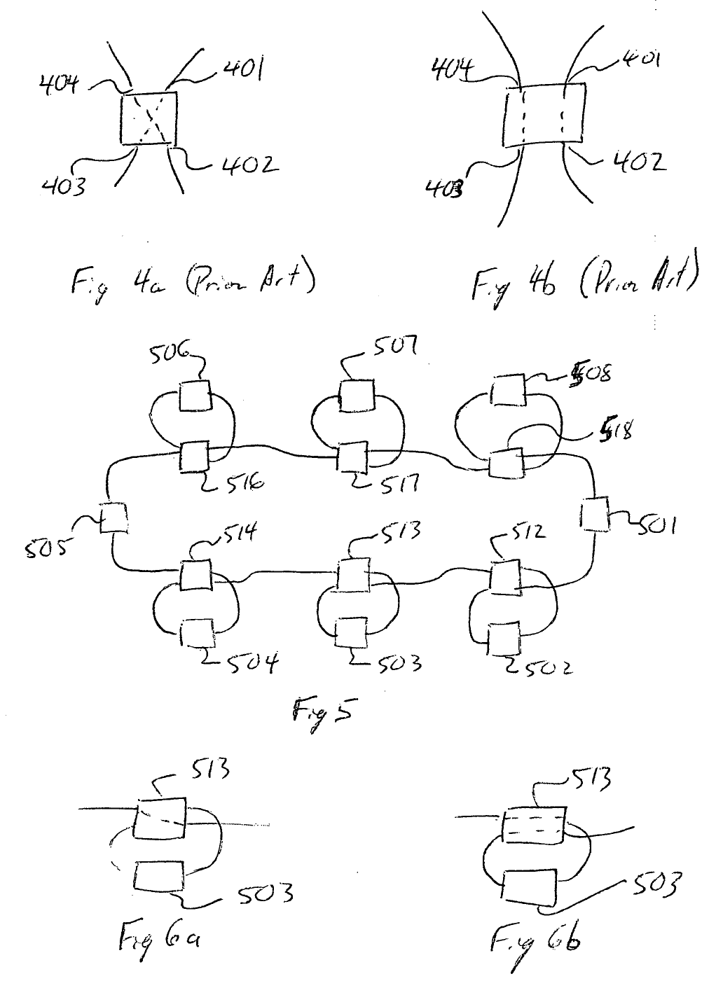

It is desired to provide an inexpensive means of ensuring that functional nodes within a Sonet network supporting add-drop functionality are capable of communicating even when intermediate nodes along both optical paths are not functional. Referring to FIG. 4a, an optically passive 2×2 switch (cross connect switch) having ports 401 to 404 is shown in a first state. In this state, an optical signal received at optical port 401 is provided to port 403 and an optical signal received at port 404 is provided to port 402. When the cross connect switch is in a second state, shown in FIG. 4b, an optical signal received by port 401 is provided to port 402 and an optical signal received by port 404 is provided to port 403. This type of switch is commercially available. For example, JDS Uniphase makes an SN 2×2 switch, among others. The cross connect switch is relatively insensitive to optical characteristics of optical signals propagating within the switch, for example, the wavelength of optical signals provided thereto. Additionally, the cross connect supports the propagation of optical signals in both directions through all of its optical ports. Each cross connect switch introduces a certain amount of insertion loss into an optical path that it supports. A person of skill in the art will appreciate the importance of insertion loss and ensure that the total insertion loss along a given path is within a desired design value.

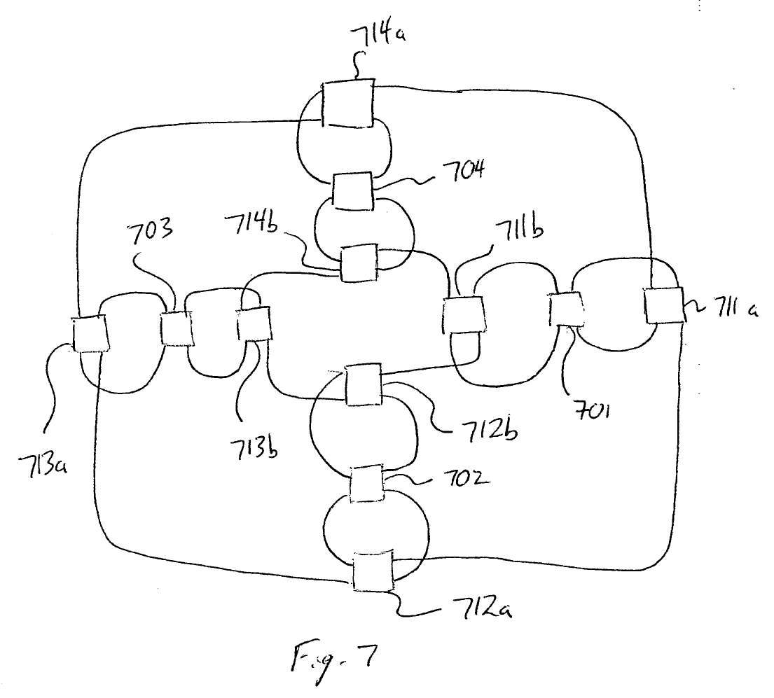

Referring to FIG. 5, a Sonet ring 500 according to a first embodiment of the invention is shown. The Sonet ring comprises nodes 501 to 508. In this system the operation of nodes 501 and 505 is considered critical whereas the operation of nodes 502 to 504 and 506 to 508 are not considered critical. Each of nodes that are not considered critical have an optical cross connect switch 512 to 514 and 516 to 518 as described with reference to FIG. 4a and FIG. 4b optically coupled thereto. Those nodes that are considered critical feature independent electrical power sources. The optical cross connect switches act to ensure that nodes that are not considered critical are bypassed when they are not receiving power. Specifically, optical cross connect switch 512 is set to divert optical signals to node 502 when the optical cross connect switch 512 is receiving sufficient electrical energy. The electrical energy provided to the optical cross connect switch 512 is provided by the node 502. Thus, when node 502 is not provided with sufficient electrical energy, the electrical energy provided to the optical cross connect switch 512 is no longer sufficient and consequently optical signals from the network are prevented from being received by node 502. Similarly, when the switch is in this state, node 502 is prevented from providing optical signals to other nodes of the network. When sufficient electrical energy is provided to node 502 following an unexpected electrical supply failure the node 502 optionally undergoes a predetermined diagnostic procedure prior to providing sufficient electrical energy to the optical cross connect switch 512. In the event that the predetermined diagnostic procedure indicates that there is a problem with the node 502 then the node optionally acts to prevent providing electrical energy to the optical cross connect switch 512.

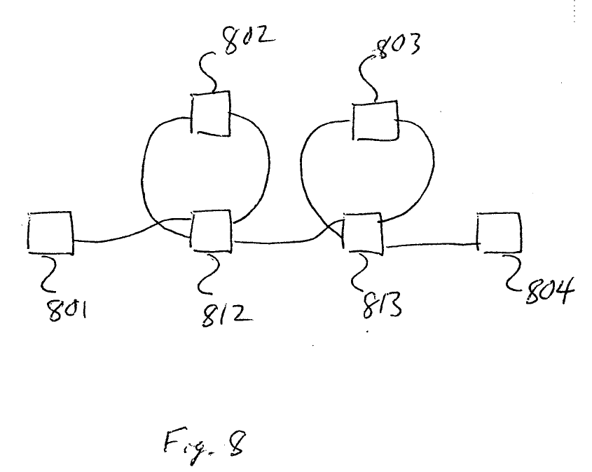

Referring to FIG. 6a, when node 503 is not receiving an appropriate level of power, the cross connect switch 513 is maintained in a first state that optically isolates node 503 from the remainder of the Sonet ring 500. Similarly, when node 503 is receiving an appropriate level of power, switch 513 is maintained in a second state that permits optical communication between node 503 and the other nodes of the Sonet ring 500. Referring to FIG. 6b, when the node 503 is receiving an appropriate level of power, the cross connect switch 513 is maintained in a second state that optically couples the node 503 to the Sonet ring 500. In this way, the Sonet ring 500 is able to recover rapidly whenever one of the nodes experiences a power failure. In the prior art network of FIG. 2, when node 203 loses power there is only one optical communications path between nodes 201 and 205. Additionally, in the system of FIG. 5 when nodes 503 and 507 lose power, there are still two available communications paths between nodes 501 and 505. In contrast, when nodes 203 and 207 of FIG. 2 lose power, there are no available communications paths between 201 and 205. A person of skill in the art will appreciate that the ability to decouple nodes as described with reference to the first embodiment of the invention is also useful when a node is in need of maintenance or replacement but there is a desire not to disrupt communication between the remaining nodes. Additionally, it is sometimes the case that an optical network will provide data indicative of a failure within the network but a precise source of the failure is difficult to determine. In order to find the fault in the network it is beneficial to test certain portions of the network and optionally decouple specific components or specific sets of components to assist in determining the nature of the problem.

A person of skill in the art will appreciate that there are numerous ways of electrically powering the cross connect switch 513 to provide the desired functionality as described with reference to FIG. 6a and FIG. 6b. Specifically, some cross connect switches are maintained in a first state when receiving power and a second state when they do not receive power. In this case, it is a simple matter to only provide power to the cross connect switch when the node is appropriately powered. This type of switch is described as “non-latching.” The JDSU SR2×2 switch is non-latching switch suitable for this application. Optical switches that are described as “latching” change their state in response to a suitable electrical pulse and otherwise remain in their current state. Beneficially, the optical node and switch configuration according to the invention is optically provided by retrofitting an existing node with an optical cross connect switch along with appropriate control hardware. The design and fabrication of such hardware is not beyond the understanding of a person of skill in the art. It is recommended that when retrofitting an existing node the optical cross connect switch be fusion spliced into the node and the network ring to provide a robust and low insertion loss optical connection. The optical cross connect switch should be powered via the control hardware in a fashion consistent with the invention such that it supports a first state when the node loses power and a second state when the node is powered. Clearly, using the example of the first embodiment of the invention, it is a simple matter to connect an optical switch to a steady state electrical power source within the node such that the optical cross connect changes state in response to changes in the status of the electrical energy supply of the node.

Further a person of skill in the art will appreciate that in a network according to the first embodiment of the invention as described with reference to FIG. 4, any node is optionally fitted with a cross connect switch in order to ensure that the communication paths to and from the node are controllably decoupled from the remainder of the optical network.

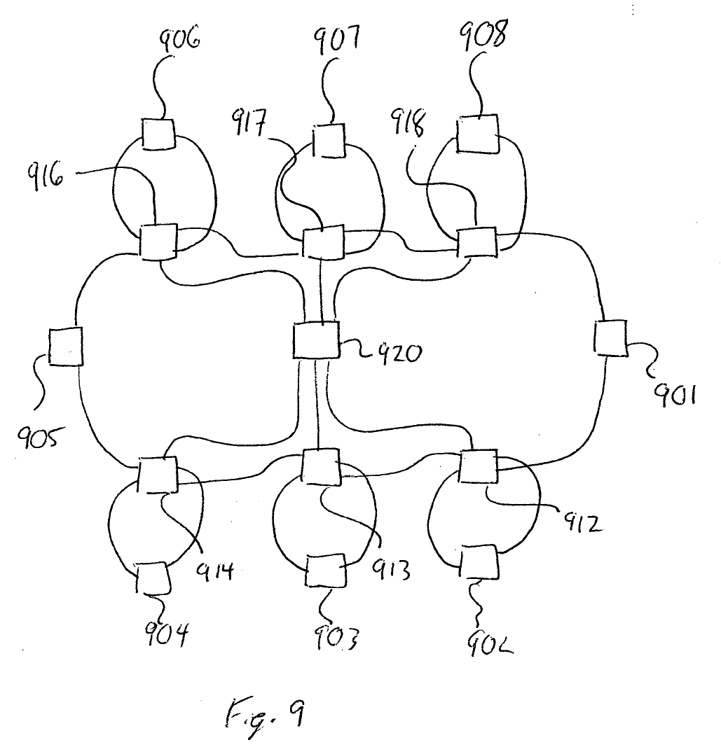

Referring to FIG. 7, a unidirectional path switch ring (UPSR) network 700 according to a second embodiment of the invention is shown having nodes 701 to 704 a first ring 709a and a second ring 709b. Each of the nodes is supported by two cross connect switches 711a and b to 714a and b. The switches are coupled to their associated nodes in a fashion that causes them to change state thereby preventing optical signals from being provided to their associated node when the node does not receive a predetermined amount of power. Similarly, when an appropriate level of power is provided to the node the switches maintain another optical path that supports optical communication between the node and the rings 709a and 709b.

A person of skill in the art will appreciate that a wide variety of different switching optical network topologies are also supported according to the invention. For example, the network shown in FIG. 5 is consistent with a single ring bi-directional line switched ring (BLSR) network. A person of skill in the art will appreciate that a BLSR based network supporting either two or four fibers is optically modified to support node failure protection as taught according to the invention. Additionally, a person of skill in the art will appreciate that the system according to the invention relies upon diverting signals from specific nodes while those signals are in the optical domain. As such, there is no protocol dependency in the system according to the invention. Similarly, the cross connect switches incorporated in the various embodiments of the invention optionally support the propagation of optical signals having a relatively wide range of wavelengths. In this way, the system according to the invention is optionally implemented with a network that makes use of wavelength division multiplexing (WDM) technology.

Referring to FIG. 8, a linear Sonet network 800 having four nodes 801 to 804 according to a second embodiment of the invention is shown. The middle nodes 802 and 803 are equipped with optical cross connect switches 812 and 813 respectively as described with reference to FIG. 4a and FIG. 4b. Unlike a ring network, a linear network supports a single communications path. Therefore, in prior art linear networks supporting add-drop functionality the loss of a node disposed between two other nodes would disrupt communications between the two other nodes. Using the system according to the third embodiment of the invention, when, for example, node 802 loses power, optical cross connect switch 812 causes optical signals to bypass node 802 thereby supporting communication between the other nodes 801, 803 and 804. Conversely, when node 802 receives sufficient power, switch 812 is set to allow node 802 to communicate with adjacent nodes 801 and 803. As nodes 801 and 804 communicate with only one other node adjacent thereto, there is no benefit in providing a switch to support bypassing either of nodes 801 and 804 in the event of a lack of power to these two nodes. Clearly, in other circumstances it is desirable to isolate these nodes from the remainder of the network and, therefore, optical switches are optionally incorporated to control optical communication paths thereto and therefrom. This provides a significant improvement to the robustness of the linear Sonet network 800.

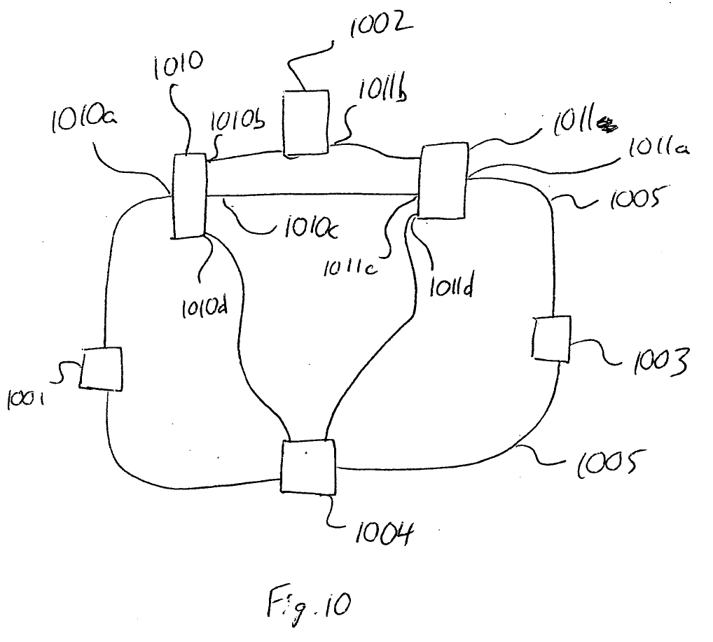

Referring to FIG. 9, a Sonet ring 900 according to a third embodiment of the invention is shown. The Sonet ring 900 comprises nodes 901 to 908. In this system the operation of nodes 901 and 905 is considered critical whereas the operation of nodes 902 to 904 and 906 to 908 are not considered critical. Each of nodes that are not considered critical have an optical cross connect switch 912 to 914 and 916 to 918 as described with reference to FIG. 4a and FIG. 4b optically coupled thereto. Those nodes that are considered critical 911 and 915 feature independent electrical power sources. The optical cross connect switches act to ensure that nodes that are not considered critical are bypassed when they are not receiving power. The Sonet ring 900 comprises a controller 920. The controller 920 is coupled to each of the cross connect switches 902 to 904 and 906 to 908. The controller 920 provides signals used to change the state of the cross connect switches 902 to 904 and 906 to 908. Thus, in the system according to the third embodiment of the invention, a sensor system (not shown) alerts the controller 920 regarding the status of the nodes 901 to 908. The controller 920 then optionally optically decouples nodes from the Sonet ring 900. A person of skill in the art will appreciate that there are a wide variety of differing applications for the system according to the third embodiment of the invention. For example, when the sensors are used for detecting unauthorized access to a node, the controller 920 severs the optical connection between the Sonet ring 900 and that node. Alternatively, if it is desired to send a high security message between node 901 and node 905 in a way that ensures that the message is not intercepted at any of the less secure nodes 902 to 904 and 906 to 908, the controller 920 receives a request for secure communication and sets the optical switches 912 to 914 and 916 to 918 to prevent communication between the Sonet ring 900 and said less secure nodes. In this case, only nodes 901 and 905 remain optically coupled to the Sonet ring 900 and, therefore, the relative security of nodes 902 to 904 and 906 to 908 is less of a concern. Specifically, if a hacker were able to gain access to data present on any of nodes 902 to 904 and 906 to 908 the hacker would not be able to access the high security data being transmitted. Once the need for secure data transmission has passed, the switches 912 to 914 and 916 to 918 are set to permit the associated nodes to communicate with the network. As even relatively slow electro mechanical optical switches are able change state in approximately 10 milliseconds the reconfiguration of the Sonet network according to the third embodiment of the invention is relatively very quick. Optionally, nodes 901 and 905 support optical properties that are not supported by all of the other nodes, such as additional wavelength channels and higher bit rates per channel. Thus, when the controller 920 separates nodes 902 to 904 and 906 to 908 the remaining nodes 901 and 905 optionally communicate at a much higher rate thereby reducing the length of time necessary to provide the secure data. In addition, when a sensor associated with a node detects a problem with the power supply of an associated node a sensor signal is provided to the controller 920. The controller 920 determines the severity of the electrical power supply problem. Further, the controller 920 optionally supports a control interface. The control interface supports a set of maintenance instructions that simplify the decoupling of one or more nodes for maintenance as well as replacement.

Referring to FIG. 10, a schematic diagram of a mesh network 1000 according to a fourth embodiment of the invention is shown. The mesh network 1000 comprises nodes 1001, 1002, 1003 and 1004, data links 1005, and optical switches 1010 and 1011. The optical switches 1010 and 1011 support an optical connection from an input port 1010a and 1011a to any one of three corresponding output ports 1010b, 1010c, 1010d, 1011b, 1011c and, 1011d. In this embodiment of the invention the switches 1010 and 1011 are synchronized such that the switches are maintained in a similar state. Thus, when switch 1010 is providing an optical connection from 1010a to 1010b then switch 1011 is set to provide an optical connection from 1011a to 1011b. The nodes of the mesh network support add-drop functionality. In use, when it is desired to provided data from node 1001 to node 1003 a data path is established from node 1001 to node 1003 via node 1002. If node 1002 goes into a bypass-mode then a new data path is established in which the data signal propagates proximate to node 1002 but is diverted from node 1002. In a first instance, the mesh network 1000, the data signal propagates from node 1001 towards the temporarily bypassed node 1002 and is routed to node 1004. Nodes 1001, 1002 and 1003 are shown as each having two ports for coupling to the data links 1005. In contrast node 1004 is shown as having four such ports. From node 1004, the data signal propagates to node 1003 where it is received. In a second instance the node 1002 is bypassed and the data propagates along the following data path: node 1001, port 1010a, port 1010c, port 1011c, port 1011a, node 1003. It is suggested for conventional data traffic applications that all the switches used in routing data traffic in a mesh network be controlled and monitored using a same controller. Clearly, any of a variety of ways of controlling the switches is optionally implemented. The mesh network of FIG. 10 only shows optical switches proximate the node 1002. A person of skill in the art will appreciate that other embodiments of the invention feature different switching configurations for different nodes. Clearly, providing optical switches having more ports allows a larger number of paths to be supported. A person of skill in the art will appreciate that there are a wide variety of configurations of mesh networks that will benefit from disposing optical switches proximate the nodes of the network according to the invention. Further, it will be appreciated by a person of skill in the art that providing additional paths for data between nodes where the additional data paths are redundant when all of the equipment is functional provides a higher level of robustness for the network. Specifically, each additional data path provides an alternative route supporting a desired flow of data when another path is unavailable. A controller for specifying the various switch states and the corresponding optical paths optionally specifies a given optical path configuration based upon a wide variety of criteria. For example, a given controller optionally supports detection of malfunctioning nodes as well as nodes that are in need of maintenance and configures the optical switches to optically decouple such nodes from the network. Similarly, the controller optionally acts to avoid optical paths that are suspect or known to be damaged. The same controller optionally sets the switches in response to a request for transmitting a secure data message.

A person of skill in the art will appreciate that an existing optical network is optionally retrofitted with appropriate switching hardware and controllers to provide the functionality described with reference to the aforementioned embodiments of the invention. Thus, for example, an existing Sonet network is optionally upgraded to provide enhanced survivability, security and ease of maintenance without replacing the Sonet nodes. As upgrading an existing optical network to provide the functionality of an optical network according to the invention does not require replacement of the optical nodes, such an upgrade is typically quite inexpensive. As the nodes of existing optical networks ages and is increasingly subject to failure, the retrofitting these optical nodes to support the advanced functionality of the previously described embodiments of the invention becomes increasingly desirable.

Numerous other embodiments of the invention will be apparent to one of skill in the art without departing from the spirit and the scope of the invention. For example, alternative embodiments of the invention feature sets of 1×2 switches instead optical cross connect switches. Further, the embodiments described above feature mechanical optical switches. Mechanical optical switches provide excellent optical properties however they are slow and subject to mechanical failure. A person of skill in the art will appreciate that there are a variety of suitable devices for switching optical signals and that many of said devices are suitable for use with the invention.

Additionally, a person of ordinary skill in the art will be aware that Sonet and SDH are related standards pertaining to optical communication networks. Specifically, Sonet is an American standard published by the American National Standards Institute (also known as ANSI) and SDH is an international standard provided by the International Telecommunications Union (ITU). Such a person will appreciate that the embodiments of the invention described with reference to Sonet rings and Sonet networks are equally applicable to SDH rings and SDH networks. Acronyms such as UPSR and BLSR are specific to Sonet networks but have SDH equivalents. The corresponding SDH equivalent terms are SNCP and MS-spring respectively. Further, it will be apparent to a person of skill in the art that the embodiments of the invention are not dependent upon specific communications protocols used by the network. Specifically, it is convenient to describe the embodiments of the invention as being used in a Sonet network however this need not be the case. Clearly, it would not be beyond the understanding of a person of skill in the art of optical network design to apply the teachings of the invention to optical networks that are not Sonet networks. Thus, the invention is equally applicable to, for example, optical Ethernet and other optical network protocols that need not be Sonet compatible. Further, a person of skill in the art will appreciate that there are a variety of scenarios in which it is beneficial to selectably optically isolate optical nodes from an optical network based upon an input signal provided by a human being. Additionally, there are a variety of circumstances where it is beneficial to optically isolate nodes in an optical network based upon a software program running on a computer.

What is claimed is:

1. An optical network comprising:
a controller;
a plurality of nodes, each of the nodes supporting add-drop functionality, each of the nodes comprising at least an optical port;
at least one of the plurality of nodes optically coupled with an optical switch comprising:
a control input port for receiving a first control signal;
an at least an optical switch port optically coupled to the at least an optical port for providing an optical signals thereto and for receiving optical signals therefrom;
a first optical port for being coupled for receiving an optical signal from the optical network; and,
a second optical port for being coupled for providing an optical signal to the optical network;
the at least one of the plurality of nodes comprising a control output port for providing a status signal for use by the controller for providing the first control signal therefrom, the control output port being other than the at least an optical port, and;
the switch being responsive to the first control signal and having a first state and a second state such that in the first state an optical signal propagating to the first optical port propagates to the at least an optical port and an optical signal provided from the at least an optical port propagates to the second optical port and, when the switch is in the second state an optical signal propagating to the first optical port propagates to the second optical port.

2. An optical network according to claim 1, comprising a control panel in data communication with the controller, the control panel for providing commands to the controller in response to a user input signal.

3. An optical network according to claim 1, wherein the at least one of the plurality of nodes comprises a first sensor, the first sensor for providing the status signal to the control output port, and another of the plurality of nodes comprises a second sensor for providing a second status signal, each of the first sensor and the second sensor in data communication with the controller.

4. An optical network according to claim 3, wherein the status signal and the second status signal comprise electrical signals.

5. An optical network according to claim 3, wherein the first sensor is for providing data indicative of a request to propagate secure data between the at least one of the plurality of nodes and another of the plurality of nodes.

6. An optical network according to claim 5, wherein the controller is for providing a command signal for optically decoupling a node other than the at least a node from remaining optically coupled nodes of the plurality of nodes.

7. An optical network according to claim 1, wherein the optical switch is an optically passive electromechanical switch.

8. An optical network according to claim 1, wherein the optical switch comprises an attenuator.

9. An optical network according to claim 3, wherein each of the plurality of nodes is for communicating data in accordance with Sonet protocol.

10. An optical network according to claim 9, wherein the nodes of the plurality of nodes are optically coupled to form a UPSR network.

11. An optical network according to claim 9, wherein the nodes of the plurality of nodes are optically coupled to form a BLSR network.

12. An optical network according to claim 3, wherein each of the plurality of nodes is for communicating data in accordance with optical ethernet protocol.

13. An optical network according to claim 3, wherein each of the plurality of nodes is for communicating data in accordance with ATM protocol.

14. An optical network according to claim 1, wherein the control signal is an electrical signal provided by the node, the control signal other than provided in dependence upon optical signals provided to the at least an optical port.

15. A method of directing data signals in an optical system comprising:
providing an optical network comprising a set of nodes in optical communication via a set of waveguides;
providing a first node;
providing an optical switch optically disposed between the optical network and the first node, the optical switch having a first state in which optical data traffic between the optical network and the node is supported and a second state in which optical data traffic between the optical network and the node is other than supported; and,
receiving a control instruction provided independent of said set of waveguides, the control instruction for controlling a state of the switch.

16. A method according to claim 15, wherein the control instruction is provided external to the node.

17. A method of directing data signals in an optical system according to claim 16, comprising: providing a central controller, the central controller for providing control instructions to the optical switch.

18. A method of directing data signals in an optical system according to claim 17, comprising:
providing a set of sensors for monitoring the node and the plurality of the nodes, each of the sensors for providing a sensor feedback signal to the central controller and wherein the central controller determines the control instruction to be provided in dependence upon the sensor feedback signals.

19. A method of directing data signals in an optical system according to claim 18, comprising:
providing a second optical switch optically disposed between a second node of the plurality of nodes and the remaining nodes of the plurality of nodes, the second optical switch having a first state in which optical data traffic between the remaining nodes of the plurality of nodes and the second node is supported and a second state in which optical data traffic between the remaining nodes of the plurality of nodes and the second node is other than supported; and,
providing a second control instruction to the second optical switch, the second control instruction for controlling a state of the second switch.

20. A method of directing data signals in an optical system according to claim 18, wherein providing a second control instruction comprises providing a second control instruction from the central controller.

21. A method of directing data signals in an optical system according to claim 20, wherein the optical network is a linear optical network.

22. A method of directing data signals in an optical system according to claim 20, wherein the optical network is a ring optical network.

23. A method of directing data signals in an optical system according to claim 20, wherein the optical network is a mesh optical network.

24. A method of directing data signals in an optical system according to claim 15, comprising:
monitoring an electrical signal within the node, and;
changing a state of the switch in response to a change in the monitored electrical signal.

25. A method of directing data signals in an optical system according to claim 24, wherein the electrical signal is an electrical energy supply signal.

26. A method of directing data signals in an optical system according to claim 17, wherein the optical switch comprises an input port and at least three output ports such that an input signal coupled to the input port is optically routed to any one of the at least three output ports.

27. A method of directing data signals in an optical system according to claim 26, wherein a first of the at least three output ports corresponds to a first optical path to a first optical destination and a second of the at least three output ports corresponds to a second optical path to the first optical destination.

28. A method of directing data signals in an optical system according to claim 27, wherein the first optical destination is a node of the set of nodes.

29. A method of directing data signals in an optical system comprising:
providing an optical network comprising a set of nodes in optical communication via a set of waveguides;
providing a controller, the controller for providing a first control signal and a second control signal;
providing a first node;
providing a first optical switch optically disposed between the optical network and the first node, the first optical switch having a first state in which optical data traffic between the optical network and the node is supported and a second state in which optical data traffic between the optical network and the first node is other than supported, the first optical switch having a first input port for receiving a first input signal other than via the set of waveguides, the first optical switch for changing state in response to the first control signal;
providing a second node;
providing a second optical switch optically disposed between the optical network and the second node, the second optical switch having a first state in which optical data traffic between the optical network and the second node is supported and a second state in which optical data traffic between the optical network and the second node is other than supported, the second optical switch having a second input port for receiving a second input signal other than via the set of waveguides, the second optical switch for changing state in response to the second control signal.

30. A method according to claim 29, comprising determining the first control signal in dependence upon an electrical power input to the first node.

31. A method according to claim 29, comprising:
providing a first sensor in communication with the controller, the first sensor for monitoring a status of the first node and providing information to the controller in dependence thereon; and,
providing a second sensor in communication with the controller, the second sensor for monitoring a status of the second node and providing information to the controller in dependence thereon.

32. A method according to claim 31, comprising:
providing a first input signal corresponding to any one of three states supported by the first optical switch; and,
providing a second input signal corresponding to any one of three states supported by the second optical switch.

33. A method according to claim 32, wherein one of the three states supported by the first optical switch supports providing a first optical path between the first node and another node of the plurality of nodes and another of the three states supported by the first optical switch supports providing a second optical path between the first node and the another node, the another of the three states other than supporting the first optical path.
